(19) United States
(12) Patent Application Publication
(10) Pub. No.: US 2006/0008000 A1
(43) Pub. Date: Jan. 12, 2006

(54) Fully scalable 3-d overcomplete wavelet video coding using adaptive motion compensated temporal filtering

(75) Inventors: Jong C. Ye, Croton-On-Hudson, NY (US); Mihaela van der Schaar, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: koninikjkled phillips electronics n.v.

(21) Appl. No.: 10/531,195

(22) PCT Filed: Oct. 8, 2003
(86) PCT No.: PCT/IB03/04452

§ 371 Date: Apr. 13, 2005

(30) Foreign Application Priority Data
Oct. 16, 2002 (US) 60418961
Jun. 30, 2003 (US) 60483796

(51) Int. Cl. H04B 1/66

(52) U.S. Cl. 375/240

(57) ABSTRACT

A method and device for coding video where a video signal is spatially decomposed into at least two signals of different frequency sub-bands, an individualized motion compensated temporal filtering scheme is applied to each sub-band signal adaptively according to signal contents, and texture coding is applied to each of the motion compensated temporally filtered subband signals adaptively according to the signal content.

This application claims the benefit under 35 USC 119(e) of U.S. provisional application Ser. No. 60/418,961, filed on Oct. 16, 2002, which is incorporated herein by reference.

The present invention relates to video compression, and more particularly to overcomplete wavelet video coding using adaptive motion compensated temporal filtering.

Current video coding algorithms are mainly based on hybrid-coding schemes with motion compensated predictive coding. In such hybrid schemes, temporal redundancy is reduced using motional compensation and spatial resolution is reduced by transform coding the residue of motion compensation. These hybrid-coding schemes, however, are prone to error propagation and lack flexibility in terms of providing true scalable bitstream, i.e., the ability to decompress to different quality, resolution, and frame-rate layers from the same compressed bitstream.

In contrast, 3D sub-band/wavelet coding can provide very flexible scalable bitstream and higher error resilience. Wavelet-based scalable video coding schemes permit great flexibility in terms of the different scalability types allowed. Hence, they are especially useful for video transmission over heterogeneous wireless and wired networks, to various devices with different capabilities.

Currently, there are two wavelet-based video coding schemes: overcomplete wavelet and interframe wavelet. In overcomplete (OW) wavelet video coding, the spatial wavelet transform for each frame is performed first, followed by exploitation of interframe redundancy by predicting the wavelet coefficient values, or by defining temporal contexts in entropy coding. In interframe wavelet video coding, wavelet filtering is performed along the temporal axis followed by a 2D spatial wavelet transform.

Present interframe wavelet video coding schemes use motion compensated temporal filtering (MCTF), to reduced the temporal redundancy. MCTF is performed in the temporal direction of motion before spatial decomposition is performed. Such video coding schemes are referred to herein as spatial domain MCTF (SDMCTF). However, the quality of the matches provided by the motion estimation algorithm inherently limit SDMCTF video coding schemes. For example, some of the interframe wavelet-coded sequence appears to be slightly blurred, because imperfect motion estimation causes movement of frame details into the temporal high frequency sub-bands, and from there, to spatial high frequency sub-bands. These artifacts lead to degraded visual performance for unquantized and spatially scaled sequences. Further tests have indicated that decreasing the number of temporal decomposition levels can reduce the artifacts.

In present OW video coding schemes, wavelet filtering is used to spatially decompose each of the video frames into multiple sub-bands, and temporal correlation for each sub-band is removed using motion estimation.

There have been many attempts to predict the wavelet coefficients by motion compensation in the wavelet domain. However, motion compensation in the wavelet domain is highly dependent on the alignment of the signal and the discrete grid chosen for the analysis. There exist very large differences between the wavelet coefficients of the original image and the one-pixel-shifted image. This shift-variant property happens frequently around the image edges, so motion compensation of the wavelet coefficients can be difficult.

Existing OW video coding schemes overcome the inefficiency of motion estimation in wavelet domain by utilizing the odd-phase wavelet coefficients in the prediction as well. A convenient method of obtaining the odd phase coefficients is to perform band shifting. Since the decoded previous frame is also available at the decoder, prediction from overcomplete expansion does not require any additional overhead. Moreover, the computational complexity of searching both optimal phase and motion vectors in wavelet domain is comparable to that of conventional motion estimation in spatial domain with fractional pel accuracy.

However, due to the motion estimation/compensation, the conventional OW framework suffers from drift, which results in performance loss in SNR scalability. Furthermore, only limited range of temporal scalability can be achieved using B frames.

Accordingly, a wavelet-based video-coding scheme with improved SNR and temporal scalability is needed.

The present invention is directed to a method and device for coding video. According to a first aspect of present invention, a video signal is spatially decomposed into at least two signals of different frequency sub-bands. An individualized motion compensated temporal filtering scheme is applied to each sub-band signal. Texture coding is then applied to each of the motion compensated temporally filtered subband signals. According to a second aspect of the invention, a signal including at least two encoded motion compensated temporally filtered, different frequency sub-band signals of a video signal, is decoded. Inverse motion compensated temporal filtering is independently applied to each of the decoded at least two sub-band signals. The at least two sub-band signals are spatially recomposed and the video signal is reconstructed from at least one of the at least two spatially recomposed sub-band signals.

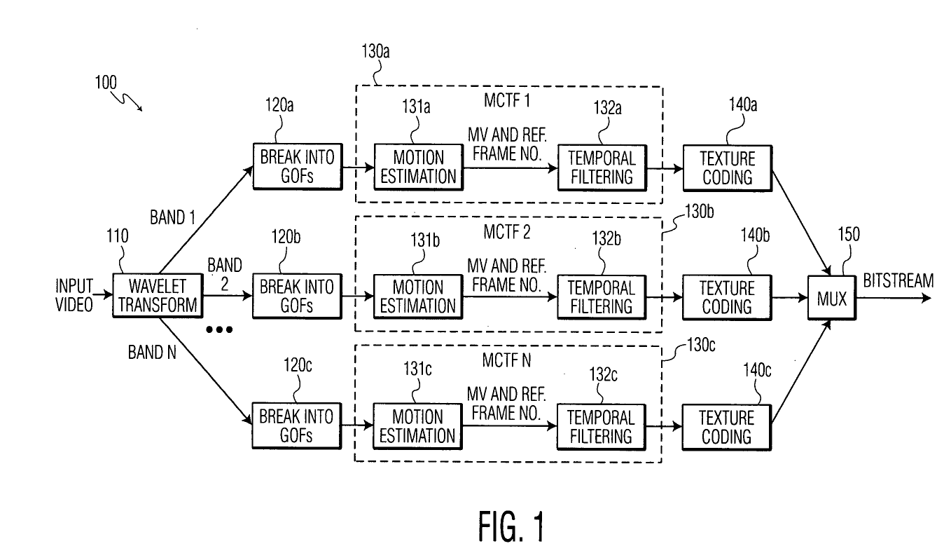

FIG. 1 is a block diagram of a 3-D overcomplete wavelet video encoder according to an exemplary embodiment of the present invention, which may be used for performing the IBMCTF method of present invention.

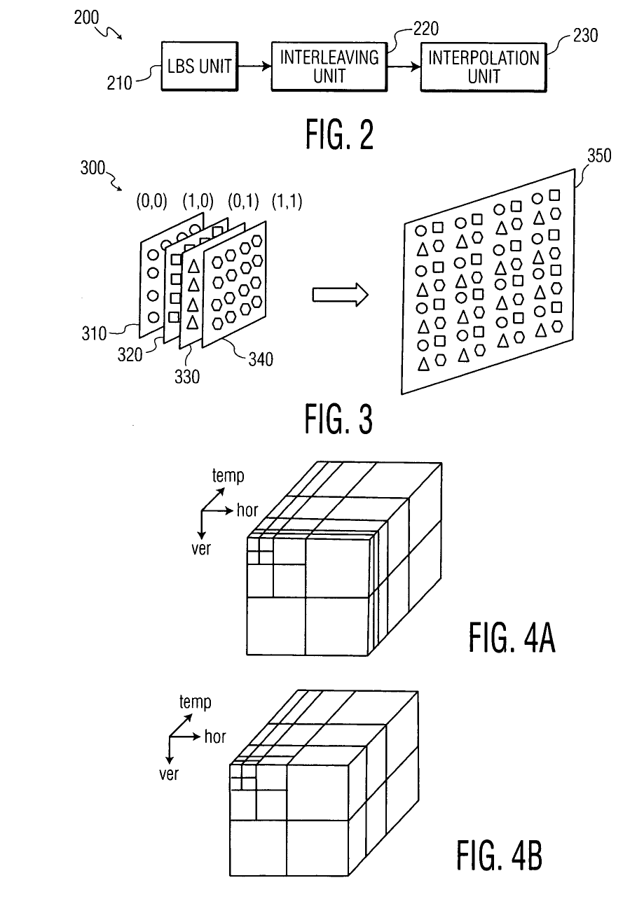

FIG. 2 is a block diagram of an adaptive higher order interpolation filter used in the present invention.

FIG. 3 illustrates the generation of an extended reference frame for motion estimation from overcomplete expansion of wavelet coefficients according to the present invention.

FIG. 4A illustrates a decomposition scheme for conventional MCTF that generates blurred images.

FIG. 4B illustrates a decomposition scheme used in the present invention.

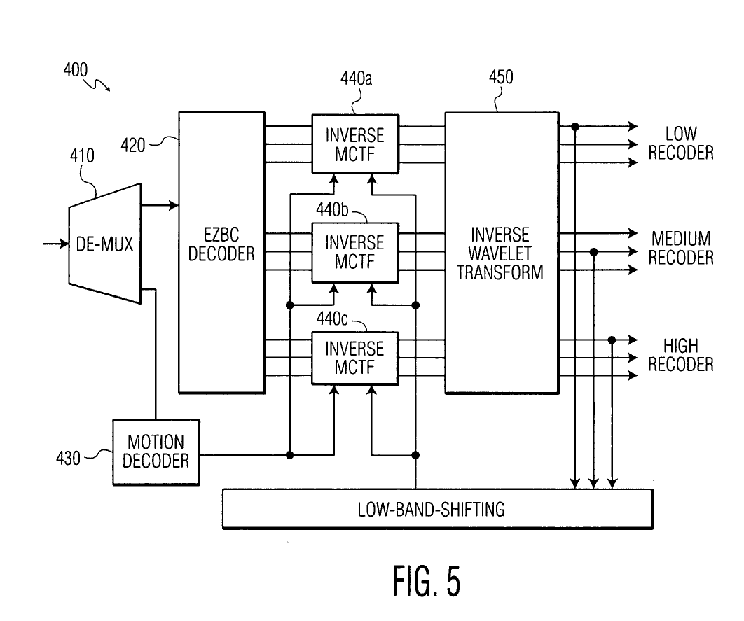

FIG. 5 is a block diagram of a 3-D overcomplete wavelet video decoder according to an exemplary embodiment of the present invention.

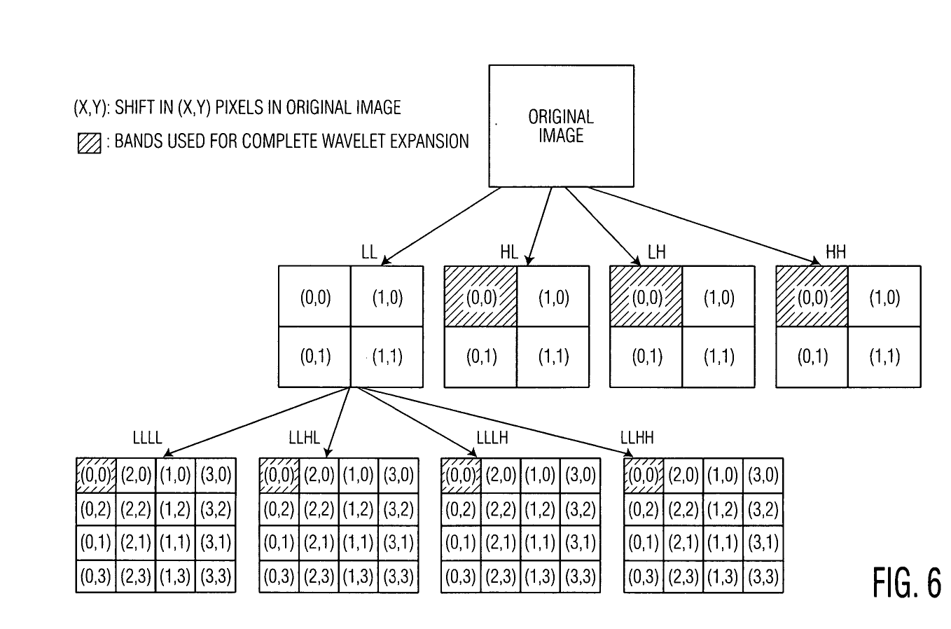

FIG. 6 shows an over-complete wavelet expansion using a LBS algorithm for two level decompositions.

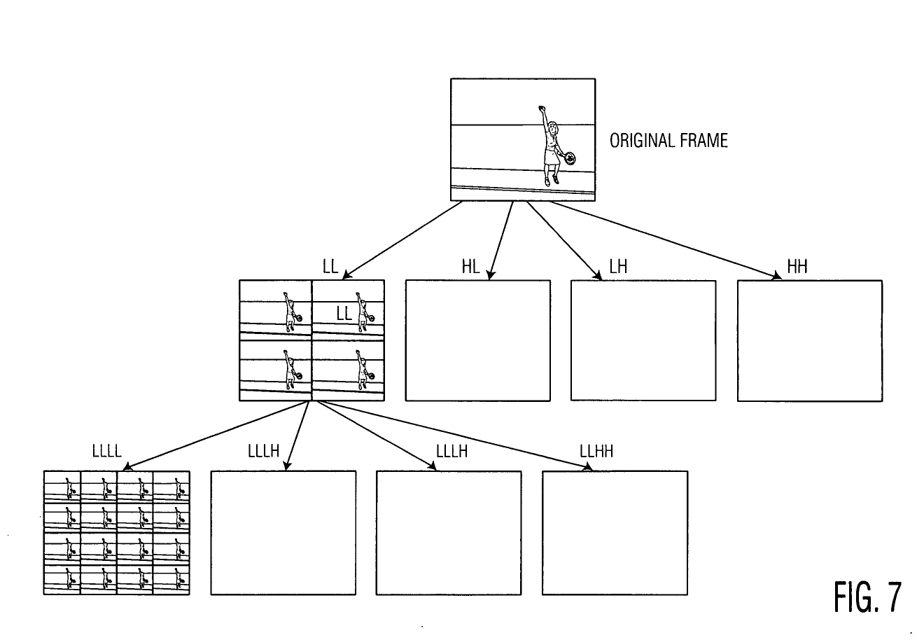

FIG. 7 is a video of a 2-level overcomplete wavelet transform obtained using the LBS method.

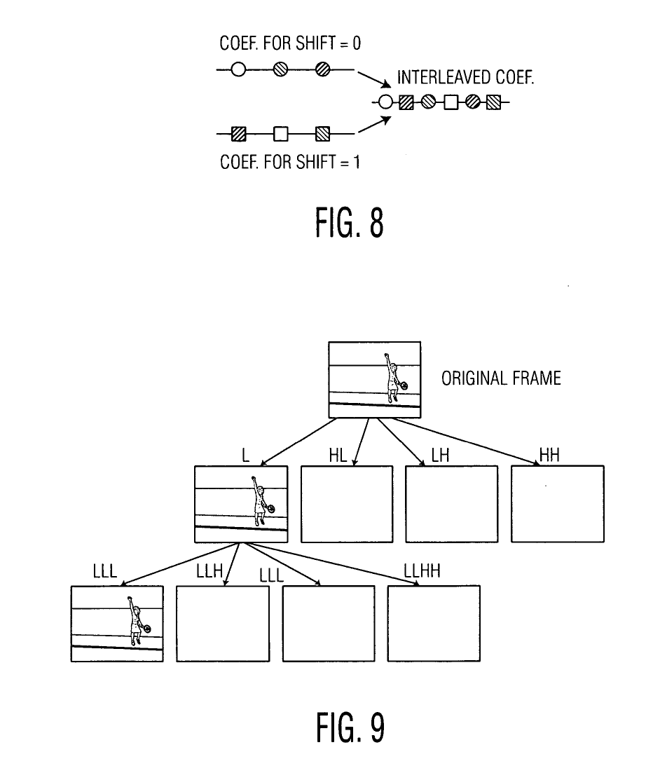

FIG. 8 illustrates the interleaving scheme of the present invention for a 1-D case of a one level decomposition.

FIG. 9 shows the overcomplete wavelet coefficients of the first frame of the video of FIG. 7 after performing the interleaving process of the present invention.

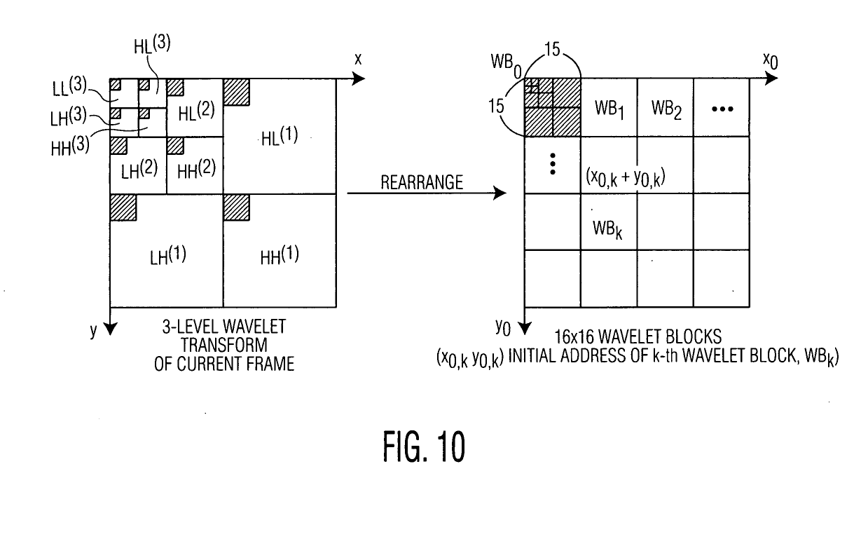

FIG. 10 is a wavelet block form by the LBS algorithm.

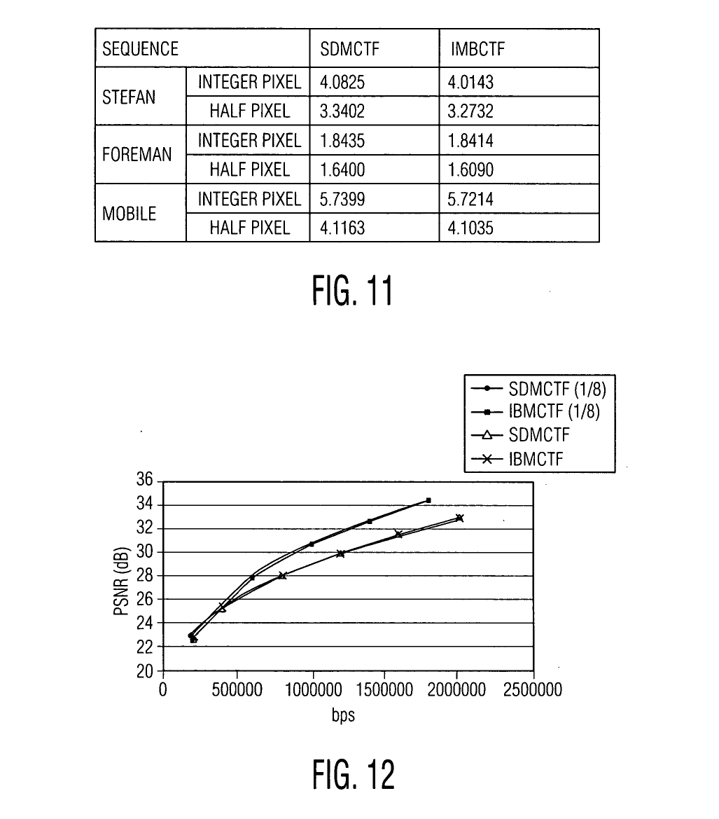

FIG. 11 shows a Table that illustrates the MAD in wavelet domain for temporal high sub-band frames.

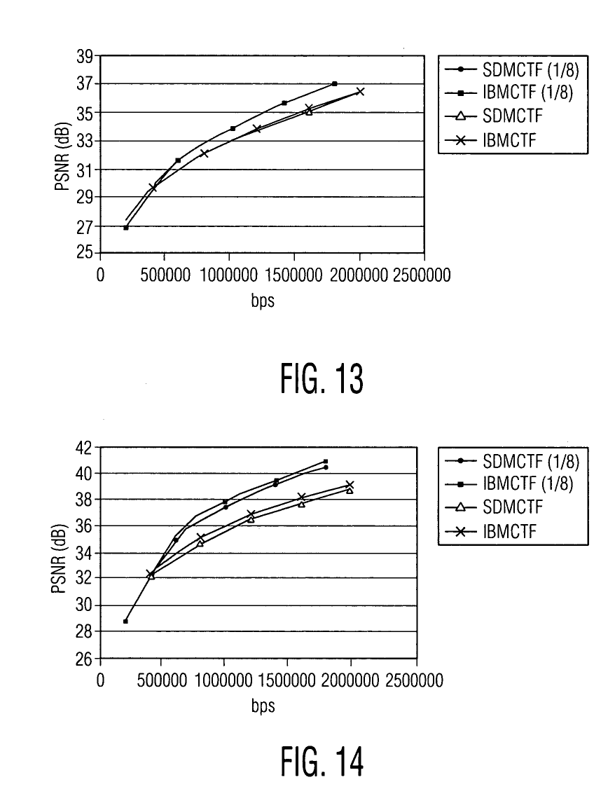

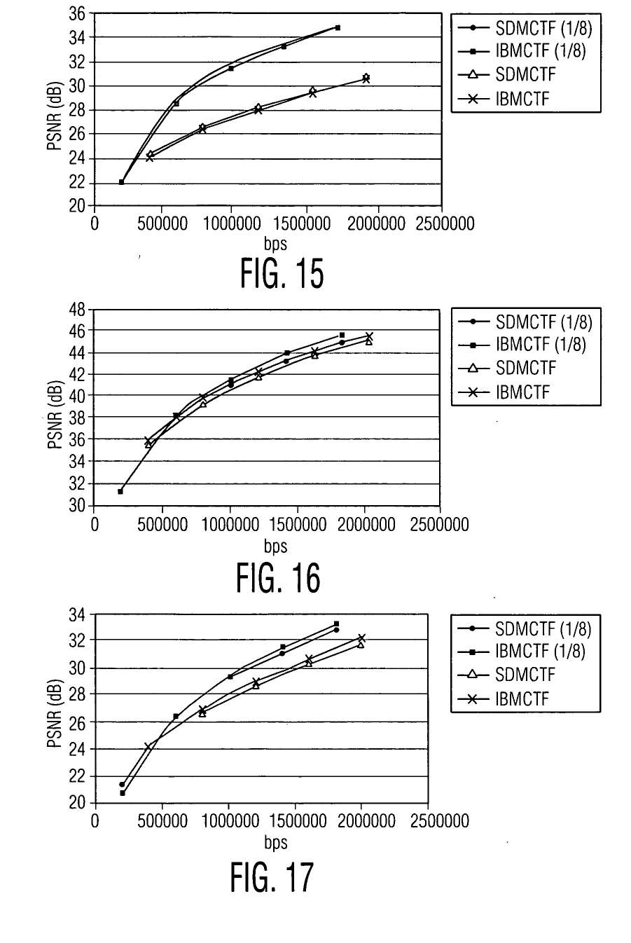

FIGS. 12-17 plot the rate distortion performance of the IBMCTF video coding scheme of the present invention and SDMCTF for several test sequence for integer and ⅛-pel accurate motion estimation.

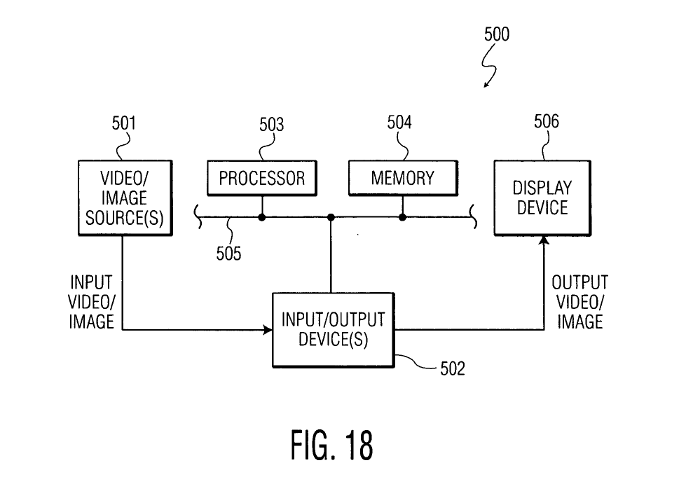

FIG. 18 is an exemplary embodiment of a system which may be used for implementing the principles of the present invention.

The present invention is a fully scalable three-dimensional (3-D) overcomplete wavelet video coding scheme that utilizes a novel inband motion compensated temporal filtering (IBMCTF) method. The IBMCTF method of the present invention overcomes the drawbacks of previous IBMCTF coding methods, and demonstrates coding efficiency comparable or better than conventional interframe wavelet coding methods that utilize spatial domain motion compensated temporal filtering.

FIG. 1 is a block diagram of a 3-D overcomplete wavelet video encoder according to an exemplary embodiment of the present invention, which may be used for performing the IBMCTF method of present invention. The video encoder 100 includes a 3-D wavelet transform unit 110 that spatially decomposes each video frame of an input video into any desired number of multiple sub-bands 1, 2, . . . and N using a conventional 3-D overcomplete wavelet filtering process.

The video encoder 100 further includes a partitioning unit 120a, 120b, 120c for each sub-band generated by the wavelet transform unit 110. Each partitioning unit 120a, 120b, 120c divides the wavelet coefficients of its associated sub-band into groups of frames (GOFs) for encoding as a group.

The video encoder 100 also includes a motion compensated temporal filtering (MCTF) unit 130a, 130b, 130c for each sub-band, that contains a motion estimator 131a, 131b, 131c and a temporal filter 132a, 132b, 132c. Each MCTF 130a, 130b, 130c separately removes temporal correlation or redundancy from the GOFs of each sub-band using a motion compensated temporal filtering (MCTF) process. In accordance with the present invention, the use of a discrete MCTF unit for each sub-band allows the motion compensated temporal filtering process to be tailored for each sub-band independently of the other sub-bands. In addition, the temporal filtering process selected for a particular sub-band may be based on different criteria.

The encoder additionally includes a texture encoder 140a, 140b, 140c for each sub-band that allows the residual signal and motion information (motion vectors) generated by the MCTF units 130a, 130b, 130c for each sub-band to be independently texture coded using any optimized texture coding process. The texture coded residual signals and motion information are then combined into a single bitstream by a multiplexer 150. Another embodiment of texture coding is a gobal transform of a full size residual frame, which is applied after the all residual signals and motion information generated by the MCTF units 130a, 130b, 130c for each sub-band are combined to generate the full size residual frame.

As one of ordinary skill in the art will appreciate, the critical-sampled wavelet decomposition in known IBMCTF methods is only periodically shift-invariant. Therefore, performing motion estimation and compensation in the wavelet domain is inefficient and may incur a coding penalty. To address this problem, each motion compensated filtering unit 130a, 130b, 130c utilizes an adaptive higher order interpolation filter 200, as shown in FIG. 2, to maximize the performance of the motion estimator 131a, 131b, 131 c. The interpolation filter 200 of the invention includes a low band shifting (LBS) unit 210 that performs low band shifting, an interleaving unit 220 that performs overcomplete wavelet coefficient interleaving, and an interpolation unit 230. The LBS process is implemented in the LBS unit 210 with one or more known LBS algorithms that efficiently generate an overcomplete representation of the original wavelet coefficients, which is now shift invariant. LBS advantageously generates the overcomplete expansion of the original wavelet coefficients at the encoder and decoder using one or more similar LBS algorithms, therefore, no additional information needs to be encoded and transmitted as compared to conventional interframe wavelet coding schemes.

The interleaving process, performed by the interleaving unit 220, combines the different phase information provided by the overcomplete wavelet coefficients to generate an extended reference frame. Accordingly, there is no need to encode the phase information separately as in previous IBMCTF based video coding methods. Due to the interleaving process of the present invention, the phase information is coded inherently as part of the higher accuracy motion vectors.

From the extended reference frame, the interpolation unit 230 generates a fractional pel, such as ½, ¼, ⅛, 1/16 pels, which is used by the motion estimator 131a, 131b, 131c for motion estimation. Interpolation may be implemented with a conventional one-dimensional interpolation filter. In order to maximize the performance of the motion estimation and MCTF, independently optimized interpolation filters with a different tap can be used for each subband. FIG. 3 illustrates the generation of an extended reference frame for motion estimation from overcomplete expansion of wavelet coefficients according to the present invention. In order to achieve a higher order interpolation for motion estimation in the HH sub-band overcomplete expansion 300, for example, three other phases of wavelet coefficients are generated from original wavelet coefficients 310 by shifting the lower sub-band with the amount of (1,0), (0,1) and (1,1). Then, four phases of wavelet coefficients 310, 320, 330, 340 are interleaved to generate an extended reference frame 350.

The IBMCTF based 3-D overcomplete wavelet video coding method of the present invention provides improved spatial scalability performance as compared with known spatial domain motion compensated temporal filtering (SDMCTF) based video coding methods. This is because the temporal filtering is performed per sub-band (resolution) and hence, loss of information from the finer resolution sub-bands does not incur any drift in the temporal direction.

As mentioned earlier, the use of a discrete MCTF unit 130a, 130b, 130c for each sub-band allows different temporal filtering techniques to be used at the various resolutions. For example, in one embodiment, a bi-directional temporal filtering technique can be used for low resolution sub-bands, while a forward temporal filtering technique can be used for higher resolution sub-bands. The temporal filtering technique can be selected based on minimizing a distortion or a complexity measure (e.g. the low resolution sub-bands have less pixels and hence bi-directional and multiple reference temporal filtering can be employed, while for the high resolution sub-bands that have a larger number of pixels, only forward estimation is performed). Such a flexible choice of temporal filtering options makes moves the invention away from the strict 1D+2D decomposition schemes as performed by MCTF, to a more general 3-D decomposition scheme with spatial size reduction throughout the temporal levels, where the higher spatial frequency sub-bands are omitted from longer-term temporal filtering.

The use of a discrete partitioning unit 120a, 120b, 120c for each sub-band allows the GOFs to be adaptively determined per sub-band. For instance, the LL-sub-bands might have a very large GOF, while the H-sub-bands can use limited GOFs. The GOF sizes can be varied based on the sequence characteristics, complexity or resiliency requirements. As mentioned earlier, the decomposition scheme for conventional MCTF, as shown in FIG. 4A, generates blurred images. However, the use of different temporal decomposition levels and GOF sizes allows the 3-D wavelet scalable video coding scheme of the present invention to overcomes such drawbacks. As shown in FIG. 4B, GOF sizes for LL LH (HL), and HH may be 8, 4, and 2 frames, respectively, which allow maximum decomposition levels of 3, 2, and 1 respectively. This way the higher spatial frequency sub-bands are omitted from longer-term temporal filtering.

The number of temporal decomposition levels for the various sub-bands can be determined either based on content, or to reduce a specific distortion metric or simply based on the desired temporal scalability in each resolution. For instance, if 30, 15 and 7.5 Hz frame-rates are desired at CIF (352×288) size resolution, and only 30 and 15 at SD (704×576) size resolution, then for the LL spatial-sub-band, three levels of temporal decomposition are used, while only two levels of temporal decomposition can be applied for LH, HL, and the HH sub-bands.

As also mentioned earlier, the use of discrete texture coding unit 140a, 140b, 140c for each sub-band allows adaptive texture coding of the various spatial sub-bands. For example, wavelet or DCT-based texture coding schemes may be used. If DCT-based texture coding is used, intra-coded blocks can be advantageously inserted anywhere within the GOF to deal efficiently with covering and uncovering situations. Also, “adaptive intra-refresh” concepts from MPEG-4/H.26L can be easily employed to provide improved resiliency, and different refresh rates can be used for the various sub-bands to obtain different resiliencies. This is especially beneficial since the lower resolution sub-bands can be used for concealing the higher resolution sub-bands and hence, their resiliency is more important.

Another advantage of the present invention relates to the complexity scalability of the decoder. If there are many decoders with different computation power and displays, the same scalable bitstream can be used to support all those decoders through SNR/spatial/temporal scalability. For example, the scalable bitstream generated by the encoder of the invention can be decoded with a decoder with low complexity that can decode only low resolution spatial and temporal decomposition level, which incurs only small computational burden. Similarly, the scalable bitstream generated by the encoder of the invention can also be decoded with a decoder having sophisticated decoding power that can decode the whole bit stream to achieve the full spatial and temporal resolution.

FIG. 5 is a block diagram of a 3-D overcomplete wavelet video decoder according to an exemplary embodiment of the present invention. The decoder may be used for decoding the bitstream produced by the encoder of the present invention. The video decoder 400 may include a demultiplexer 410 that processes the bitstream to separate the encoded wavelet coefficients from the motion information.

A first texture decoder 420 texture decodes the wavelet coefficients, according to the inverse of the texture coding technique performed on the encoding side, into their separate sub-bands 1, 2, . . . and N. The wavelet coefficients of a sub-band produced by the first texture decoder 420 correspond to each GOF of that sub-band. A motion vector decoder 430 decodes the motion information for each sub-band according to the inverse of the texture coding technique performed on the encoding side. Using the decoded motion vectors and residual texture information, inverse MCTF is applied by MCTF units 440a, 440b, 440c for each sub-band independently and an inverse wavelet transform unit 450 spatially recomposes each sub-band to reconstruct the low, medium, and high level images. The low-band-shifting block reads the recomposed sub-band images to assemble a full size image and then the low band shifted wavelet decomposition is applied to provide the extended reference frames for the inverse MCTF units 440a, 440b, 440c. Depending on the display resolution, a video reconstruction unit (not shown) may use one of the sub-bands to generate the low resolution video, or use two sub-bands to generate a medium resolution video, or use all of the sub-bands to generate a high resolution, full quality video.

The various processes utilized in the video scheme of the present invention will now be described in greater detail below.

### Motion Estimation and Compensation in the Overcomplete Wavelet Domain

### 1. Low Band Shifting Method (LBS)

The decimation process performed in a wavelet transform generates wavelet coefficients that are no longer shift-invariant. Hence, translation motion in the spatial domain cannot be accurately estimated from the wavelet coefficients, which in turn produces a significant loss in coding efficiency. The LBS algorithms utilized in the present invention provide a method for overcoming the shift-variant property of the wavelet transform. At a first level, the original and shifted signals are decomposed into low-sub-band and high-sub-band signals. Subsequently, the low-sub-band signal is further decomposed in the same way as for the first level.

FIG. 6 shows an over-complete wavelet expansion using a LBS algorithm for two level decompositions. The one dimensional (1-D) formulation can be easily expanded to wavelet decompositions having multiple levels and also to two-dimensional (2-D) image signals. The pair (m,n) indicates that the wavelet coefficients within that sub-band were generated by shifts of m-pixels in the x-direction and n-pixels in the y-direction, respectively. The LBS algorithm generates a full-set of wavelet coefficients for all the possible shifts of the input sub-band. Hence, the representation accurately conveys any shift in spatial domain. As will be discussed further on, the different shifted wavelet coefficients corresponding to the same decomposition level at a specific spatial location are referred to as “cross-phase” wavelet coefficients.

FIG. 7 is a video of a 2-level overcomplete wavelet transform obtained using the LBS method. Note that for an n-level decomposition, the overcomplete wavelet representation requires a storage space that is 3n+1 larger than that of the original image.

### 2. Interleaving of Wavelet Coefficients

The novel interleaving scheme of the present invention stores the overcomplete wavelet coefficients differently from that depicted in FIGS. 6 and 7. As shown in FIG. 8, which illustrates the interleaving scheme of the present invention for a 1-D case of a one level decomposition, the coefficients for shift-interleaving is performed such that the new coordinates in the overcomplete domain correspond to the associated shift in the original spatial domain.

The interleaving scheme can be used recursively at each decomposition level and can be directly extended for 2-D signals. FIG. 9 shows the overcomplete wavelet coefficients of the first frame of the video of FIG. 7 after performing the interleaving process of the present invention. As can be seen from FIG. 9, the interleaved low sub-band signal is a low-pass filtered version of the original frame using the overcomplete wavelet low-pass filter. The interleaving process of the present invention enables the IBMCTF method of the present invention to provide sub-pixel accuracy motion estimation and compensation. Previously proposed IBMCTF schemes cannot provide optimal sub-pixel accuracy motion estimation and compensation, because they do not take into consideration cross-phase dependencies between neighbouring wavelet coefficients. Furthermore, the interleaving process allows the IBMCTF method of the invention to use hierarchical variable size block matching, backward motion compensation, and adaptive insertion of intra blocks.

### Generation of Wavelet Block

As is well known in the art, in a wavelet decomposition, every coefficient at a given scale, with the exception of those in the highest frequency sub-bands, can be related to a set of coefficients of the same orientation at finer scales. In many wavelet coders, this relationship is exploited by representing the coefficients as a data structure called a wavelet tree. In the LBS algorithm, the coefficients of each wavelet tree rooted in the lowest sub-band are rearranged to form a wavelet block, as shown in FIG. 10. The purpose of the wavelet block is to provide a direct association between the wavelet coefficients and what they represent spatially in the image. Related coefficients at all scales and orientations are included in each block.

### Structure of Motion Estimation

In the spatial domain, the block-based motion estimation usually divides an image into small blocks and then finds the block of the reference frame that minimizes the mean absolute different (MAD) to each block of the current frame. The motion estimation of the LBS algorithm finds the motion vector (dx, dy) that generates the minimum MAD between the current wavelet block and the reference wavelet block. As an example, if an input image is decomposed up to the third level (i.e. the input image can be decomposed to a total of ten sub-bands), and the displacement vector is (dx,dy), then the MAD of the k-th wavelet block in FIG. 10 is computed as follows:

$${MAD}_{k} ( dx , dy ) = {\sum }_{i = 1}^{3} {\sum }_{{x}_{i} = {x}_{i , k}}^{{x}_{i , k} + M / {2}^{i}} {\sum }_{{y}_{i} = {y}_{i , k}}^{{y}_{i , k} + N / {2}^{i}} \{ \vert {HL}_{cur}^{( i )} ( {x}_{i ,} {y}_{i} ) - {HL}_{ref}^{( i )} ( dx \% {2}^{i} , dy \% {2}^{i} ; {x}_{i} + ⌊ \frac{dx}{{2}^{i}} ⌋ , {y}_{i} + ⌊ \frac{dy}{{2}^{i}} ⌋ ) \vert + \vert {LH}_{cur}^{( i )} ( {x}_{i ,} {y}_{i} ) - {LH}_{ref}^{( i )} ( dx \% {2}^{i} , dy \% {2}^{i} ; {x}_{i} + ⌊ \frac{dx}{{2}^{i}} ⌋ , {y}_{i} + ⌊ \frac{dy}{{2}^{i}} ⌋ ) \vert + \vert {HH}_{cur}^{( i )} ( {x}_{i ,} {y}_{i} ) - {HH}_{ref}^{( i )} ( dx \% {2}^{i} , dy \% {2}^{i} ; {x}_{i} + ⌊ \frac{dx}{{2}^{i}} ⌋ , {y}_{i} + ⌊ \frac{dy}{{2}^{i}} ⌋ ) \vert \} + {\sum }_{{x}_{i} = {x}_{3 , k}}^{{x}_{3 , k} + M / {2}^{i}} {\sum }_{{y}_{i} = {y}_{3 , k}}^{{y}_{3 , k} + N / {2}^{i}} \vert {LL}_{cur}^{( 3 )} ( {x}_{i ,} {y}_{i} ) - {LL}_{ref}^{( 3 )} ( dx \% {2}^{3} , dy \% {2}^{3} ; {x}_{i} + ⌊ \frac{dx}{{2}^{3}} ⌋ , {y}_{i} + ⌊ \frac{dy}{{2}^{3}} ⌋ ) \vert$$

where x_{i,k}=x_{0,k}/2ⁱ and y_{i,k}=y_{0,k}/2ⁱ; and (x_{0,k}, y_{0,k}) denotes the initial position of the k-th wavelet block in the spatial domain, as shown in FIG. 10 and └x┘ denotes largest integer not bigger than x. Here, for example, the i-th level HL sub-band of the reference frame is represented by HL_{ref}⁽ⁱ⁾(m, n; x, y), where (m,n) denotes the number of shift in x- and y-direction in the spatial domain and (x,y) is the location of the sub-band signal. The optimization criterion for the motion estimation is now finding the optimal (dx,dy) which minimizes this MAD. Note that in the original LBS algorithm, for the non-integer value of (dx,dy), it is not possible to compute the MAD using the above formula. More specifically, the MAD in conventional IBMCTF video coding schemes is based solely on the same-phase wavelet coefficients and the resulting sub-pixel accuracy motion estimation and compensation is not optimal.

However, in the IBMCTF method of the present invention, the interleaving process enables the MAD calculation to be performed similarly as in SDMCTF video coding schemes, even for the sub-pixel accuracy. More specifically, the MAD for the displacement vector (dx,dy) for the IBMCTF method of the present invention is computed as follows:

$${MAD}_{k} ( dx , dy ) = {\sum }_{i = 1}^{3} {\sum }_{{x}_{i} = {x}_{i , k}}^{{x}_{i , k} + M / {2}^{i}} {\sum }_{{y}_{i} = {y}_{i , k}}^{{y}_{i , k} + N / {2}^{i}} \{ \vert {HL}_{cur}^{( i )} ( {x}_{i ,} {y}_{i} ) - {LBS\_HL}_{ref}^{( i )} ( {2}^{i} {x}_{i} + dx , {2}^{i} {y}_{i} + dy ) \vert + \vert {LH}_{cur}^{( i )} ( {x}_{i ,} {y}_{i} ) - {LBS\_LH}_{ref}^{( i )} ( {2}^{i} {x}_{i} + dx , {2}^{i} {y}_{i} + dy ) \vert + \vert {HH}_{cur}^{( i )} ( {x}_{i ,} {y}_{i} ) - {LBS\_HH}_{ref}^{( i )} ( {2}^{i} {x}_{i} + dx , {2}^{i} {y}_{i} + dy ) \vert \} + {\sum }_{{x}_{i} = {x}_{3 , k}}^{{x}_{3 , k} + M / {2}^{i}} {\sum }_{{y}_{i} = {y}_{3 , k}}^{{y}_{3 , k} + N / {2}^{i}} \vert {LL}_{cur}^{( i )} ( {x}_{i ,} {y}_{i} ) - {LBS\_LL}_{ref}^{( i )} ( {2}^{i} {x}_{i} + dx , {2}^{i} {y}_{i} + dy ) \vert$$

where, for example, LBS_HL_{ref}⁽ⁱ⁾(x, y) denotes the extended HL sub-band of reference frame using interleaving process of the present invention. Note that even if (dx,dy) are non-integer values, the same interpolation technique used for SDMCTF can be easily used for each extended sub-band to generate the MAD for the non-integer displacement. Therefore, the IBMCTF video coding scheme of the present invention provides more efficient and indeed optimal sub-pixel motion estimation compared to the existing IBMCTF coding schemes. Also, in the IBMCTF video coding scheme of the present invention with the wavelet block structure does not incur any motion vector overhead because the number of the motion vector to be coded is the same as that of SDMCTF. Since the motion estimation is closely aligned with the residual coding, a more sophisticated motion estimation criterion (such as the entropy of the residual signal) may be used to improve the coding performance.

### Simulation Results

In order to verify that motion estimation and motion compensation in accordance with the present invention in the overcomplete wavelet domain yields lower residual energy in the wavelet domain, we use a one level temporal decomposition and compute the MAD for both IBMCTF and SDMCTF. Note that in interframe wavelet coding, the MAD is computed in the spatial-domain, but actually what needs to be minimized is the residual energy in the wavelet domain. FIG. 11 shows a Table that illustrates the MAD in wavelet domain for temporal high sub-band frames. The MAD values are averaged over the first 50 frames of temporal high sub-bands. For the SDMCTF cases, the corresponding MAD values in wavelet domains are computed after the wavelet transform of the residual signal. Note that the MAD for the IBMCTF is always smaller than for SDMCTF, which indicates the possible coding gain of the IBMCTF video coding scheme of the present invention over SDMCTF.

FIGS. 12-17 plot the rate distortion performance of the IBMCTF video coding scheme of the present invention and SDMCTF for several test sequence for integer and ⅛-pel accurate motion estimation. The inband structure for MCTF was computed with a two level spatial decomposition performed by a Daubechies 9/7 filter, and four levels of decomposition were used for the temporal direction. The texture coding was performed with an EZBC algorithm described in the article entitled, Invertible Three-Dimensional Analysis/Synthesis System For Video Coding With Half-Pixel Accurate Motion Compensation, by S. T. Hsiang et al., VCIP 1999, SPIE Vol. 3653, pp. 537-546. Similar to SDMCTF, the sub-pixel motion estimation using ⅛ pel greatly improves the coding performance of the IBMCTF. The overall coding performance of the IBMCTF and SDMCTF is comparable. However, some sequences such as “Coastguard”, “Silent” and “Stefan” exhibit a performance gain of up to 0.5 dB, while for the “Mobile” sequence a 0.3 dB performance degradation can be observed. Visually, the IBMCTF algorithm of the present invention is free of blocking artefacts of the motion estimation since the motion estimation and filtering is done in each sub-band and the boundary of the motion is filtered out using wavelet recomposition filter.

FIG. 18 is an exemplary embodiment of a system 500 which may be used for implementing the principles of the present invention. The system 500 may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. The system 500 includes one or more video/image sources 501, one or more input/output devices 502, a processor 503 and a memory 504. The video/image source(s) 501 may represent, e.g., a television receiver, a VCR or other video/image storage device. The source(s) 501 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 502, processor 503 and memory 504 may communicate over a communication medium 505. The communication medium 505 may represent, e.g., a bus, a communication network, one or more internal connections of a circuit, circuit card or other device, as well as portions and combinations of these and other communication media. Input video data from the source(s) 501 is processed in accordance with one or more software programs stored in memory 504 and executed by processor 503 in order to generate output video/images supplied to a display device 506.

In a preferred embodiment, the coding and decoding principles of the present invention may be implemented by computer readable code executed by the system. The code may be stored in the memory 504 or read/downloaded from a memory medium such as a CD-ROM or floppy disk. In other embodiments, hardware circuitry may be used in place of, or in combination with, software instructions to implement the invention. For example, the functional elements shown in FIGS. 1, 2, and 5 may also be implemented as discrete hardware elements.

While the present invention has been described above in terms of specific embodiments, it is to be understood that the invention is not intended to be confined or limited to the embodiments disclosed herein. For example, other transforms besides DCT can be employed, including but not limited to wavelets or matching-pursuits. These and all other such modifications and changes are considered to be within the scope of the appended claims.

1. A method of encoding video, the method comprising the steps of:
providing a video signal;
spatially decomposing the video signal into at least two signals of different frequency sub-bands;
applying an individualized motion compensated temporal filtering scheme to each sub-band signal; and
texture coding each of the motion compensated temporally filtered subband signals.

2. The method according to claim 1, wherein the spatially decomposing step is performed by wavelet filtering.

3. The method according to claim 1, wherein the video signal defines a plurality of frames, the spatially decomposing step including spatially decomposing each of the frames of the video signal into the at least two signals of different frequency sub-bands.

4. The method according to claim 1, wherein prior to the step of applying a motion compensated temporal filtering scheme, further comprising the step of breaking each of the sub-band signals into a signal representing a group of temporal frames having a certain content.

5. The method according to claim 4, wherein the individualized motion compensated temporal filtering scheme applied to each sub-band signal is individualized according to the content of the group of frames.

6. The method according to claim 1, wherein prior to the step of applying a motion compensated temporal filtering scheme, further comprising the step of breaking each of the sub-band signals into a signal representing a group of frames, the number of the frames in at least one of the group of frames signals being adaptively determined.

7. The method according to claim 1, wherein the individualized motion compensated temporal filtering scheme applied to each sub-band signal is individualized according to a spatial resolution of the sub-band signal.

8. The method according to claim 1, wherein the step of applying an individualized motion compensated temporal filtering scheme to each sub-band signal is performed by using variable accuracy motion estimation, which is dependent of signal contents.

9. The method according to claim 1, wherein the individualized motion compensated temporal filtering scheme applied to each sub-band signal is individualized according to a temporal correlation of the sub-band signal.

10. The method according to claim 1, wherein the step of applying an individualized motion compensated temporal filtering scheme to each sub-band signal is performed by using an individualized interpolation filter for maximizing motion estimation performance.

11. The method according to claim 1, wherein the individualized motion compensated temporal filtering scheme applied to each sub-band signal is individualized according to a characteristic of the sub-band signal.

12. The method according to claim 1, wherein the step of applying an individualized motion compensated temporal filtering scheme to each bandwidth signal is performed by using a temporal filter selected from the group consisting of multi-directional temporal filters and unidirectional temporal filters.

13. The method according to claim 1, wherein the step of applying an individualized motion compensated temporal filtering scheme to each sub-band signal includes the steps of:
shifting the sub-band signal, which is from a phase of wavelet coefficients generated in the spatially decomposing step, at least three times to generate three additional phases of wavelet coefficients;
interleaving the four phases of wavelet coefficients to produce an extended reference frame; and
estimating motion using the extended reference frame.

14. The method according to claim 13, wherein the spatial decomposing step is performed to provide a plurality decomposition levels, each decomposition level comprising a different frequency sub-band and wherein the step of applying the individualized motion compensated temporal filtering scheme, by performing the shifting, interleaving and estimating steps, is recursively applied for each decomposition level.

15. The method according to claim 1, wherein the step of applying an individualized motion compensated temporal filtering scheme to each sub-band signal includes the steps of:
shifting the sub-band signal, which are from a phase of wavelet coefficients generated in the spatially decomposing step, at least three times to generate three additional phases of wavelet coefficients;
combining the four phases of wavelet coefficients to produce an extended reference frame;
generating a fractional pel from the extended frame; and
estimating motion according to the fractional pel.

16. The method according to claim 14, wherein the spatial decomposing step is performed to provide a plurality decomposition levels, each decomposition level comprising a different frequency sub-band and wherein the step of applying the individualized motion compensated temporal filtering scheme, by performing the shifting, combining, generating and estimating steps, is recursively applied for each decomposition level.

17. A memory medium for encoding video, the memory medium comprising:
code for spatially decomposing a video signal into at least two signals of different frequency sub-bands;
code for applying an individualized motion compensated temporal filtering scheme to each sub-band signal; and
code for texture coding each of the motion compensated temporally filtered subband signals.

18. A device for encoding video, the device comprising:
a wavelet transform unit for spatially decomposing a video signal into at least two signals of different frequency sub-bands;
a motion compensated temporal filtering unit for each of the at least two sub-band signals, each motion compensated temporal filtering unit applying an individualized motion compensated temporal filtering scheme to its associated sub-band signal; and
a texture coding unit for each of the at least two sub-band signals, each texture coding unit texture coding its associated motion compensated temporally filtered subband signal.

19. The device according to claim 18, further comprising a partitioning unit for each of the sub-band signals, each partitioning unit breaking its associated sub-band signal into a signal representing a group of temporal frames having a certain content.

20. The device according to claim 18, wherein each motion compensated temporal filtering unit includes:
a low band shifting unit for shifting its associated sub-band signal, which is from a phase of wavelet coefficients, at least three times to generate three additional phases of wavelet coefficients; and
an interleaving unit for interleaving the four phases of wavelet coefficients to produce an extended reference frame.

21. The device according to claim 20, wherein each motion compensated temporal filtering unit further includes an interpolating unit for generating a fractional pel from the extended frame.

22. The device according to claim 21, wherein each motion compensated temporal filtering unit further includes a motion estimation unit for estimating motion according to the fractional pel.

23. A method of decoding video, the method comprising the steps of:
decoding a signal including at least two encoded motion compensated temporally filtered, different frequency sub-band signals of a video signal;
independently applying inverse motion compensated temporal filtering to each of the decoded at least two sub-band signals;
spatially recomposing the at least two sub-band signals; and
reconstructing the video signal from at least one of the at least two spatially recomposed sub-band signals.

24. The method according to claim 23, wherein the video signal is reconstructed from all of the at least two spatially recomposed sub-band signals.

25. A memory medium for decoding video, the memory medium comprising:
code for decoding a signal including at least two encoded motion compensated temporally filtered, different frequency sub-band signals of a video signal;
code for independently applying inverse motion compensated temporal filtering to each of the decoded at least two sub-band signals;
code for spatially recomposing the at least two sub-band signals; and
code for reconstructing the video signal from at least one of the at least two spatially recomposed sub-band signals.

26. A device for decoding video, the device comprising:
a texture decoding unit for decoding a signal including at least two encoded motion compensated temporally filtered, different frequency sub-band signals of a video signal;
an inverse motion compensated temporal filtering unit for each of the at least two sub-band signals, each inverse motion compensated temporal filtering unit independently applying inverse motion compensated temporal filtering to its associated decoded at least two sub-band signal;
an inverse wavelet transform unit for spatially recomposing the at least two sub-band signals; and
a video reconstructing unit for reconstructing the video signal from at least one of the at least two spatially recomposed sub-band signals.
